(19) United States
(12) Patent Application Publication
(10) Pub. No.: US 2025/0172181 A1
(43) Pub. Date: May 29, 2025

(54) FRICTION UNIT FOR A DISK BRAKE OF A VEHICLE AND BRAKE CALIPER

(71) Applicant: HL MANDO CORPORATION, Pyeongtaek (KR)

(72) Inventor: Hatem SHAHIN, Pfaffenhofen (DE)

(21) Appl. No.: 18/632,305

(22) Filed: Apr. 11, 2024

(30) Foreign Application Priority Data
Nov. 23, 2023 (DE) 102023132703.8

(51) Int. Cl. F16D 65/092; F16D 65/00; F16D 69/00

(52) U.S. Cl. CPC F16D 65/092; F16D 65/0006; F16D 69/00; F16D 65/0068; F16D 2069/005

(57) ABSTRACT

A friction unit for a disk brake of a vehicle includes a support plate, a friction pad comprising a friction material layer that includes a contact surface for contacting a disk, and an underlayer including an inner surface which is oriented opposite to the contact surface and which is joined to the support plate, wherein the underlayer comprises at least one slot formed in the inner surface.

### CROSS-REFERENCE TO RELATED APPLICATION

This application claims the benefit of German Patent Application No. 102023132703.8, filed on Nov. 23, 2023 in the German Patent Office (DPMA), the disclosures of which are incorporated herein by reference in its entirety.

### BACKGROUND

### 1. Technical Field

The present invention relates to friction unit for a disk brake of a vehicle such as an automobile, a bus, a lorry, a motorcycle or similar, and to a brake caliper.

### 2. Description of the Related Art

A friction brake for a vehicle, typically, includes a disk coupled to a rotating part of an axle of the vehicle carrying the wheel, and a brake caliper coupled to a stationary part of the axle. The brake caliper includes a carrier and a friction unit which is guided within the carrier parallel to an axis of rotation of the disk. The friction unit includes a support plate and a friction pad disposed on the support plate. For braking the wheel, the friction unit is urged towards the disk so that the friction pad is pressed against the disk by an external brake force, which may, for example, be generated by aid of hydraulic pressure, to generate a frictional force between the friction pad and the disk.

During a brake operation, in which the friction pad is in contact with the disk, relative motion between the rotor and the friction part occurs which may cause vibrations, mainly of the disk and the friction pad. Consequently, squeal noise may occur.

Various counter measures have been proposed to reduce squeal noise. For example, to reduce noise, the friction pads are typically provided with slots and/or chamfers on a contact surface that comes into contact with the disk. Such friction units, for example, are described in US 2009/0 032 343 A1 and EP 3 155 283 A1.

The slots formed in the contact surface of the friction pad have the purpose of reducing local pressure peaks when the friction pad is pressed against the disk. Although slots in the contact surface may be effective to reduce squeal noise in the first place, the effectiveness of this countermeasure may decrease over time. Since the contact surface is subject to wear, the geometry of the slots changes over lifetime of the friction pad. Further, it may happen that debris is gathered in the slots.

It is one of the objects of the present invention to provide an improved friction unit for a disk brake. In particular, it is an object to provide a robust friction unit which helps in further reducing noise during braking.

To this end, the present invention provides a friction unit in accordance with claim 1 and a brake caliper in accordance with claim 10.

According to a first aspect of the invention, a friction unit for a disk brake of a vehicle includes a support plate, and a friction pad. The friction pad comprises a friction material layer that includes a contact surface for contacting a disk, and an underlayer including an inner surface which is oriented opposite to the contact surface and which is joined to the support plate, wherein the underlayer comprises at least one slot formed therein, e.g., in the inner surface of the underlayer.

According to a second aspect of the invention, a brake caliper for a disk brake of a vehicle includes a carrier and a friction unit according to the first aspect of the invention which is movably guided within the carrier along an axial direction or fixed within the carrier.

It is one of the ideas of the present invention to provide a friction unit for a disk brake comprising a friction pad in which at least one slot is provided spaced apart from a contact surface of the friction pad. Specifically, the slot is formed in an underlayer which is sandwiched between a friction material layer of the friction pad an a support plate. The underlayer is joined to the support plate with a first or inner surface in which the one or more slots may be formed. The underlayer and the friction pad are joined to each other. Generally, the underlayer acts as a damping layer and is made of more elastic material composition than the friction material layer.

One of the advantages of the present invention is that the slot remains its geometry over lifetime of the friction unit because it is not exposed on the contact surface which is subject to wear. Further, providing the slot in the underlayer reduces noise caused by vibration very effective because the underlayer is close to the source of vibrational friction.

Further embodiments of the present invention are subject to the dependent claims and the following description, referring to the drawings.

According to some embodiments, the material composition of the underlayer may include the same components as the friction material layer but in a different percentages or one or more components may be replaced by different components. Generally, the underlayer may include one or more of the following components: acrylic fibers, aramid fibers, inorganic material, powdered rubber, small balls of rubber, binders and adhesives, nitrile rubber, ethylene propylene rubber, styrene-butadiene rubber.

According to some embodiments, the at least one slot may end at a circumference of the underlayer. The underlayer, for example, may have a circular, rectangular or substantially rectangular or other shaped circumference. The at least one slot may extend to the circumference so that it forms a cut out in the circumferential surface of the underlayer. The slot may end within the underlayer distanced to the circumference or may end at another point of the circumference.

According to some embodiments, the at least one slot may extend between opposite portions of a circumference of the underlayer. That is, the slot may completely extend through the underlayer from one point of the circumference to a different point at the circumference. For example, when the circumference is substantially rectangular and has two opposite long sides and two opposite short sides, the slot may extend from one long side to the other long side or from one short side to the other the short side.

According to some embodiments, the at least one slot extends distanced to a circumference of the underlayer. In other words, the slot may extend completely within the underlayer, e.g., start and end within the underlayer or form a closed frame such as a ring or similar.

According to some embodiments, the slot may extend linear. Alternatively, the slot may also comprise multiple linear portions connected to each other and/or may comprise curved sections.

According to some embodiments, the at least one slot may form a void. That is, the underlayer material is removed where the slot is present and no other solid or liquid material is present in the slot. Hence, the slot defines a hollow space in the underlayer. Thereby, the slots can easily be generated during the process of applying the underlayer material to the support plate, e.g., by placing webs onto the surface of the support plate, applying the underlayer material to the surface of the support plate with the webs placed thereon so that the slots are formed where the webs are placed, and removing the webs, e.g., by pulling them out from the underlayer material.

According to some embodiments, the at least one slot may be filled with a filler material. The filler material, generally, may be a material that is mechanically softer than the underlayer. For example, the filler material may be an elastically deformable material or a malleable material such as a paste. Thereby, the filler material easily deforms when pressure is applied to the friction pad during braking, so that pressure peaks are reliably dissipated. Selecting specific material properties for the filler material allows further adapting the damping properties. The filler material may be introduced in a liquid state into the slots manufactured as described above. Alternatively, the filler material may be applied to the surfaces of the backing plate first and, if required, may be cured, and afterwards the underlayer material may be applied to the surface of the support plate with the filler material placed thereon so that the slots are formed where the filler material is disposed.

According to some embodiments, the filler material may have one or more of the following properties: a bulk modulus which is at least 30% smaller than that of the underlayer; a Poisson's ratio which is at least 10% greater than that of the underlayer; a Young's modulus which is at least 20% smaller than that of the underlayer; a density which is at least 20% smaller than that of the underlayer.

According to some embodiments, the filler material may include or is made of a phenolic resin, expanded polystyrene, wood fibers, or rubber.

According to some embodiments, the underlayer has predefined thickness, and the at least one slot may have a depth smaller than the thickness of the underlayer or may have a depth being equal to the thickness of the underlayer so that it extends completely through the underlayer. The thickness of the underlayer, for example, may lie in a range between 1 mm and 3 mm. The depth of the slot may, for example, lie in a range between 0.8 mm and 3 mm, preferably between 0.8 and 2 mm.

According to some embodiments, a width of the at least one slot may, for example, lie in a range between 3 mm to 10 mm, preferably between 5 mm and 7 mm.

According to some embodiments, the contact surface of the friction material layer may be a continuous surface having a planar main portion. The main portion, for example, may form at least 85%, preferably 95% of the area of the contact surface. Hence, no slots are present in the contact surface. However, optionally, a chamfer may be formed in an end region of the contact surface. Due to the slots formed in the underlayer, no slots are necessarily required in the contact surface of the friction unit. Thereby, the disadvantages of those slots are avoided while noise and vibration are still effectively reduced.

According to some embodiments, the brake caliper may further comprise an actuator mounted in the carrier and configured to move the movably guided friction unit along the axial direction. For example, the actuator may be a piston. The piston may be driven, for example, by hydraulic pressure.

The features and advantages described herein with respect to one aspect of the invention are also disclosed for the other aspects and vice versa.

With respect to directions and axes, in particular, with respect to directions and axes concerning the extension or expanse of physical structures, within the scope of the present invention, an extent of an axis, a direction, or a structure “along” another axis, direction, or structure includes that said axes, directions, or structures, in particular tangents which result at a particular site of the respective structure, enclose an angle which is smaller than 45 degrees, preferably smaller than 30 degrees and in particular preferable extend parallel to each other.

With respect to directions and axes, in particular with respect to directions and axes concerning the extension or expanse of physical structures, within the scope of the present invention, an extent of an axis, a direction, or a structure “crossways”, “across”, “cross”, or “transversal” to another axis, direction, or structure includes in particular that said axes, directions, or structures, in particular tangents which result at a particular site of the respective structure, enclose an angle which is greater or equal than 45 degrees, preferably greater or equal than 60 degrees, and in particular preferable extend perpendicular to each other.

### BRIEF DESCRIPTION OF THE DRAWINGS

For a more complete understanding of the present invention and advantages thereof, reference is now made to the following description taken in conjunction with the accompanying drawings. The invention is explained in more detail below using exemplary embodiments, which are specified in the schematic figures of the drawings, in which:

FIG. 1 schematically illustrates a cross-sectional view of a disk brake including a brake caliper according to an embodiment of the invention.

FIG. 2 schematically illustrates a plan view to a friction surface of a friction unit according to an embodiment of the invention.

FIG. 3 schematically illustrates a cross-sectional view of the friction unit of FIG. 2 taken along line A-A.

FIG. 4 schematically shows a detailed view of the area marked in FIG. 3 by letter X.

FIG. 5 schematically illustrates the detail of FIG. 4 according to a further embodiment of the invention.

FIG. 6 schematically illustrates a plan view to a friction surface of a friction unit according to a further embodiment of the invention.

FIG. 7 schematically illustrates a plan view to a friction surface of a friction unit according to a further embodiment of the invention.

FIG. 8 schematically illustrates a plan view to a friction surface of a friction unit according to a further embodiment of the invention.

FIG. 9 schematically illustrates a plan view to a friction surface of a friction unit according to a further embodiment of the invention.

FIG. 10 schematically illustrates a plan view to a friction surface of a friction unit according to a further embodiment of the invention.

FIG. 11 schematically illustrates a plan view to a friction surface of a friction unit according to a further embodiment of the invention.

FIG. 12 schematically illustrates a cross-sectional friction unit according to an embodiment of the invention during a process of manufacturing the friction unit.

FIG. 13 schematically illustrates a plan view to a friction surface of a friction unit according to a further embodiment of the invention.

FIG. 14 schematically illustrates a plan view to a friction surface of a friction unit according to a further embodiment of the invention.

FIG. 15 schematically illustrates a plan view to a friction surface of a friction unit according to a further embodiment of the invention.

FIG. 16 schematically illustrates a plan view to a friction surface of a friction unit according to a further embodiment of the invention.

FIG. 17 schematically illustrates a plan view to a friction surface of a friction unit according to a further embodiment of the invention.

FIG. 18 schematically illustrates a plan view to a friction surface of a friction unit according to a further embodiment of the invention.

FIG. 19 schematically illustrates a plan view to a friction surface of a friction unit according to a further embodiment of the invention.

FIG. 20 schematically illustrates a plan view to a friction surface of a friction unit according to a further embodiment of the invention.

In the figures like reference signs denote like elements unless stated otherwise.

### DETAILED DESCRIPTION OF EMBODIMENTS

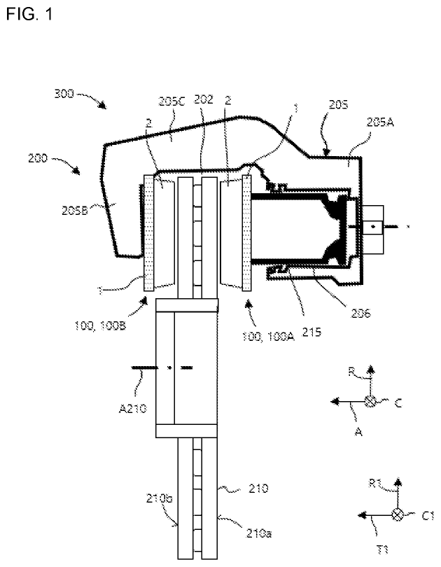

FIG. 1 schematically shows a disk brake 300 of a vehicle. The brake 300 may be employed, for example, in an automobile, a bus, a lorry, a motorcycle or similar. As schematically shown in FIG. 1, the brake 300 includes a brake caliper 200 and a disk 210.

As schematically shown in FIG. 1, the brake disk 210 will not be described in detail below. Generally, the disk 210 may have a circular shape and includes opposite friction surfaces 210a, 210b. The disk 210 is configured for being coupled to a wheel of the vehicle and is rotatable about rotational axis A210.

The brake caliper 200 is only shown in a simplified and schematic manner in FIG. 1. As shown, the brake caliper 200 comprises a carrier or housing 205, a pair of friction units 100, and an actuator in the form of a piston 215.

As schematically shown in FIG. 1, the carrier 205 may comprise a first housing portion 205A, a second housing portion 205B, and a bridge 205C.

As schematically shown in FIG. 1, the first housing portion 205A may include a guiding structure, e.g., in the form of a cylindrical bore 206 for guiding the piston 215. The second housing portion 205B is arranged opposite to the first housing portion 205A with respect to an axial direction A. As schematically shown in FIG. 1, the second housing portion 205B may extend along a radial direction R extending transverse to the axial direction A. For example, the second housing portion 205B may include, for example, two fingers spaced apart in a circumferential direction C. Alternatively, the second housing portion 205B may be plate shaped. The first and the second housing portion 205A, 205B are connected to each other by the bridge 205C which extends substantially along the axial direction A. For example, the first housing portion 205A, the second housing portion 205B, and the bridge 205C may be integrally formed.

As further schematically shown in FIG. 1, the first housing portion 205A, the second housing portion 205B, and the bridge 205C define a passage 202. The passage 202, with respect to the axial direction A, is limited by the first housing portion 205A and the second housing portion 205B and, with respect to the radial direction R, is limited by the bridge 205C. The brake disk 210 extends through the passage 202 as schematically shown in FIG. 1.

The carrier or housing 205 may be movably mounted to a coupling carrier (not shown). The coupling carrier may be mounted to a knuckle or, generally, to the axle of the vehicle. In particular. The carrier 205 may be movably guided along the axial direction A on the carrier. Generally, the axial direction A and the rotational axis A200 may be parallel to each other.

The friction units 100 are positioned on opposite sides of the passage 202 and are coupled to the carrier 205, for example, via respective clips (not shown). Generally, at least one of the friction units 100 is coupled to the carrier 205 such that it is movable by the piston 215 along the axial direction A. In the example of FIG. 1, a first friction unit 100A is movably guided along the axial direction A in the first housing portion 205A, and a second friction unit 100B is fixedly attached to the second housing portion 205B, e.g., to the fingers.

The configuration of the friction units 100 will be explained in more detail below.

The piston 215 is guided in the first housing portion 205A so as to be movable along the axial direction A to move the first friction unit 100A along the axial direction A. As exemplarily shown in FIG. 1, the piston 215 may be guided in the bore 206. The piston 215 may be moved towards and away from the passage 202 by applying hydraulic pressure to a rear end of the piston. However, the invention is not limited thereto. The piston 215 may also be moved using an electric actuator such as a motor or by aid of electromagnetic force. Further, instead of a piston 215, another suitable actuator may be used.

When the piston 215 or, generally, the actuator, moves the first friction unit 100A into contact with the friction surface 210a of the disk 210, an axial displacement of the carrier 205 takes place as the carrier 205 is movably guided. This axial displacement moves the second friction unit 100B into contact with the opposite friction surface 210b of the disk 210. Consequently, a frictional force between the friction pads 100 and the disk 210 is generated which brakes the disk 210.

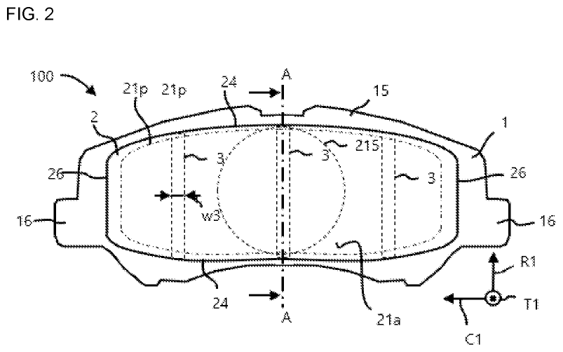

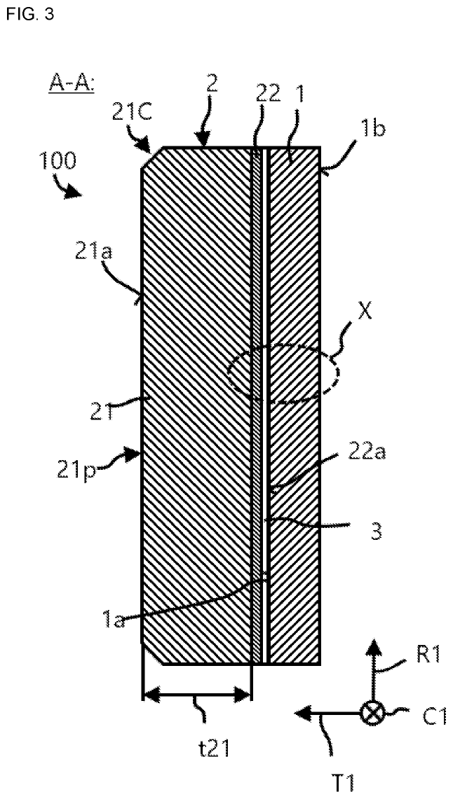

A friction unit 100 of the brake caliper 200 is exemplarily and schematically shown in a plan view in FIG. 2. FIG. 3 shows a cross-sectional view of the friction unit 100 taken along line A-A in FIG. 2. FIG. 4 shows detail X of FIG. 3.

As shown in FIGS. 2 to 4, the friction unit 100 comprises a support plate 1 and a friction pad 2.

The support plate 1 is a generally flat member having an areally expanse. The support plate 1 comprises a first surface 1a and a second surface 1b oriented opposite to the first surface 1b. As shown in FIG. 2, the support plate 1 may include a main portion 15, on which the first and second surfaces 1a, 1b are formed, and guide portions 16 that laterally protrude from the main portion 15 in opposite directions, e.g., along a friction unit circumferential direction C1. When assembled in the carrier 205, the guide portions 16 may be engaged with guiding structures (not shown) formed in the carrier 205 to axially guide the friction unit 100. The main portion of 15 may have substantially the shape of a circular segment, as exemplarily shown in FIG. 4.

The first surface 1a of the support plate 1, for example, may be a planar surface as only schematically shown in FIG. 3. Optionally, one or more recesses or protrusions (not shown) may be provided on the first surface 1a. The second surface 1b of the support plate 1 for example, may be a planar surface as only schematically shown in FIG. 3. Optionally, one or more recesses or protrusions (not shown) may be provided on the second surface 1b.

The support plate 1 is made of a mechanically rigid material. For example, the support plate 1 may be made of a metal material.

The friction pad 2 is configured for coming into contact with the disk 210 to apply a frictional force to the disk 210. The friction pad 2, therefore, comprises a first surface or contact surface 21a. The friction pad 2, as shown in FIGS. 2 and 3, is disposed on the first surface 1a of the support plate 1. The contact surface 21a of the friction pad 2 faces away from the support plate 1.

As shown in FIG. 3, the friction pad 2 comprises a friction material layer 21 and an underlayer 22.

The friction material layer 21 comprises the friction or contact surface 21a. The friction material layer 21 may be made of any known friction material suitable for being used in a friction pad of a disk brake. A thickness t21 of the friction material layer 21a with respect to a friction unit thickness direction T1 may lie in a range between 8 mm and 12 mm, for example.

The underlayer 22 is joined or integrally formed with the friction material layer 21 and is positioned on a side of the friction material layer 21 facing away from the contact surface 21a. The underlayer 22 may have a thickness t22 in a range between 1 mm and 3 mm, for example. The underlayer 22, generally, serves as a damping layer and, therefore, may be made of a material composition that has a higher elasticity than the friction material layer 21. The material composition of the underlayer 22 may, for example, include the same components as the friction material layer 21 but in a different percentages or one or more components may be replaced by different components. Generally, the underlayer 22 may include one or more of the following components: acrylic fibers, aramid fibers, inorganic material, powdered rubber, small balls of rubber, binders and adhesives, nitrile rubber, ethylene propylene rubber, styrene-butadiene rubber.

As further shown in FIG. 3, the underlayer 22 includes an inner surface 22a which is oriented opposite to the contact surface 21a. The underlayer 22, with the inner surface 22a, is joined to the support plate 1, for example, by means of an adhesive layer 5 (FIG. 4). The underlayer 22 and the friction material layer 21 at their interface each may comprise a circumference that are shaped and dimensioned accordingly. As exemplarily shown in FIG. 3, the friction pad 2 may comprise a substantially rectangular circumference. For example, the circumference of the friction pad 2, which corresponds to the circumference of the underlayer 22, may comprise two opposite long or first sides 24 extending along the friction unit circumferential direction C1, and two opposite second or short sides 26 extending along a friction unit radial direction R1. The friction unit circumferential direction C1 and the friction unit radial direction R1 extend transverse to each other. The friction unit thickness direction T1 extends transverse to the friction unit circumferential direction C1 and the friction unit radial direction R1. As exemplarily shown in FIG. 2, the long sides 24 may be curved, e.g., convex curved.

As visible in FIG. 3 and shown in more detail in FIG. 4, the underlayer 22 comprises at least one slot 3 formed in the inner surface 22a. As shown schematically in FIGS. 3 and 4, a depth d3 of the slot 3 may be smaller than the thickness t22 of the underlayer 22. Alternatively, the slot 3 may have a depth d3 equal to the thickness t22 of the underlayer 22 so that it extends completely through the underlayer 22. The depth of the slot 3 may, for example, lie in a range between 0.8 mm and 3 mm, preferably between 0.8 and 2 mm. A width w3 (FIG. 2) of the slot 3 may, for example, lie in a range between 3 mm to 10 mm, preferably between 5 mm and 7 mm. The slot 3 may have, for example, a rectangular cross-section, a triangular or trapezoid cross-section, a U-shaped cross-section or similar.

As shown schematically in FIG. 4, the slot 3 may form a void or hollow space extending between the first surface 1a of the support plate 1 or, if provided, the adhesive layer 5. Alternatively, the slot 3 may be filled with a filler material 4 as schematically shown in FIG. 5. The filler material 5, generally, may be a material that is mechanically softer than the underlayer 22. For example, the filler material 4 may be an elastically deformable material or a malleable material such as a paste. The filler material 4 may have, for example, one or more of the following properties: a bulk modulus which is at least 30% smaller than that of the underlayer 22; a Poisson's ratio which is at least 10% greater than that of the underlayer 22; a Young's modulus which is at least 20% smaller than that of the underlayer 22; a density which is at least 20% smaller than that of the underlayer 22. For example, the filler material 4 may include or be made of a phenolic resin, expanded polystyrene, wood fibers, or rubber. It is also possible that the adhesive material of the adhesive layer 5 may form the filler material 4.

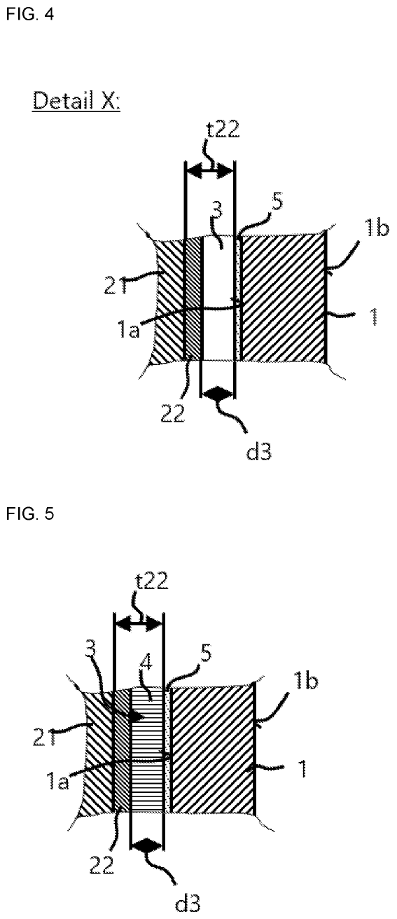

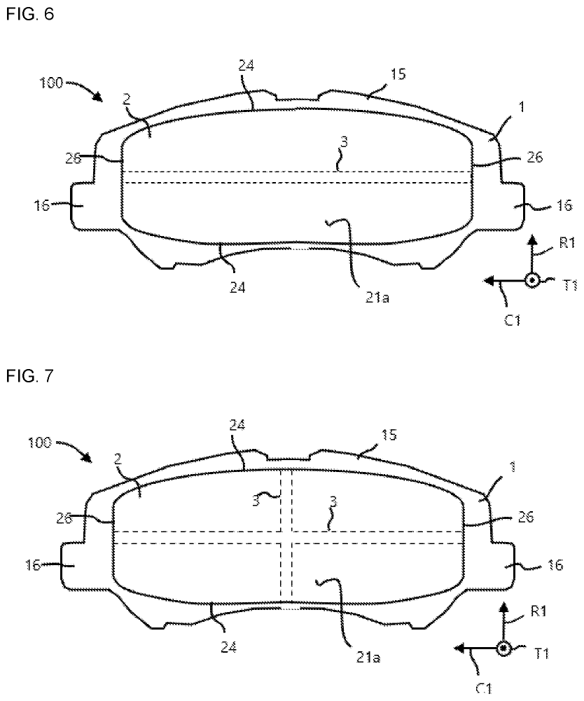

As exemplarily shown in FIG. 2, underlayer 22 may include more than one slot 3, e.g., three slots 3 extending in parallel to each other. In FIG. 2, the slots 3 are shown in dashed lines because FIG. 2 shows a top view to the friction surface 21a. As exemplarily shown in FIG. 2, the slots 3 may be spaced to each other in the friction unit circumferential direction C1 and may extend along the friction unit radial direction R1. As further shown in FIG. 2, the slots 3 may extend between and end at the opposite long sides 24 of the circumference of the underlayer 22. The invention, however, is not limited to the number, positioning and orientation of slots 3 shown in FIG. 3 and many variants are possible, as will be explained in more detail below by reference to FIGS. 6 to 20 below. In FIG. 2, instead of three slots 3, also only one slot 3, two slots 3 or more than three slots 3 may be provided.

Referring again to FIG. 1, when an external force is applied to the friction pad 100 to press the friction pad 2 against the disk 210, the friction pad 100 may start to vibrate. Vibration, on the one hand, is cause by the relative movement between the disk 210 and the friction pad 100 and, on the other hand, may be even promoted due to an uneven pressure distribution over the friction surface 21a. FIG. 2 exemplarily shows a friction unit 100 that may be advantageously employed as the first friction unit 100A in FIG. 1. Hence, it is pressed towards the disk 210 by the piston 215. As schematically shown in FIG. 2, the piston 215 applies force mainly in a central region of the friction unit 100 which may result in an uneven pressure distribution. The vibration the friction unit 100 may cause squeal noise.

The underlayer 22 helps in damping the vibrations of the friction pad 2. By providing at least one slot 3, e.g., three slots 3 as shown in FIG. 2, the underlayer 22 is locally mechanically weakened. Thereby, the friction material layer 21 may further deform in those regions where a slot 3 is formed. Consequently, pressure peaks in the friction surface 21a are reduced when the friction unit 100 is pressed against the disk 210 and, in turn, also squeal noise can be reduced. Further, since the slots 3 are formed in the underlayer 22, i.e., beneath the friction material layer 21, they are not subject to wear or dirt. Consequently, it is possible to provide the contact surface 21a of the friction material layer 21 as a continuous surface having a planar main portion 21p. The main portion 21p is schematically indicated by a chain line in FIG. 2. For example, the main portion 21p may form at least 85%, preferably 95% of the area of the contact surface 21a. In particular, when the main portion 21p is provided as planar, continuous surface, no slots are present in the main portion 21p of the contact surface 21a. However, optionally, a chamfer 21C may be formed in an end region of the contact surface.

As exemplarily shown FIG. 2 and also in FIGS. 6 to 11, the slot 3 or the slots 3 may extend between opposite portions 24, 26 of a circumference of the underlayer 22. However, the invention is not limited thereto. Generally, the slot 3 may end at a circumference of the underlayer 22. For example, a slot 3 may be provided that extends between the circumference and another slot 3, as schematically shown in FIG. 9. Alternatively, the slot 3 may also end at the circumference of the underlayer 22 and end within the underlayer 22. Moreover, it is also possible that a slot 3 extends distanced to a circumference of the underlayer 22, that is, the slot 3 may extend completely within the underlayer 22, as exemplarily shown in FIGS. 13 to 20. It is also possible to combine any of these variants.

FIGS. 6 to 8 show friction units 100 that may be advantageously used as first friction units 100A in the brake caliper 200 of FIG. 1. That is, they may be moved by the piston 215.

As exemplarily shown in FIG. 6, in contrast to FIG. 2, the underlayer 22 may also include a slot 3 that extends along the friction unit circumferential direction C1 between the opposite short sides 26. FIG. 6 exemplarily shows only one single slot 3 but also more than one slot 3 may be provided.

FIG. 7 exemplarily shows a friction unit 100 in which the underlayer 22 comprises one slot 3 extending along the friction unit radial direction R1 between the opposite long sides 24, and one slot 3 extending along the friction unit circumferential direction C1 between the opposite short sides 26, wherein the slots 3 cross each other, e.g., in a central portion of the inner surface 22a of the underlayer 22.

In the following, a slot 3 extending along the friction unit circumferential direction C1 may also be referred to as a tangential slot 3, and a slot extending along the friction unit radial direction R1 may also be referred to as a radial slot 3.

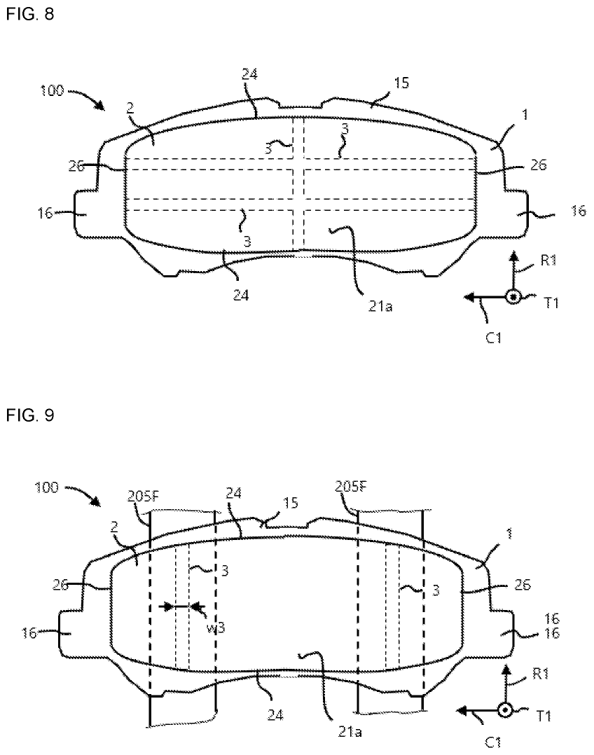

FIG. 8 exemplarily shows a friction unit 100 which differs from that of FIG. 7 only in that two tangential slots 3 are provided that extend between the opposite short sides 26.

FIGS. 9 to 11 show friction units 100 that may be advantageously used as second friction units 100B in the brake caliper 200 of FIG. 1. That is, they may be pressed against the disk 210 by the second housing portion 205B, e.g., by its fingers 205F.

As exemplarily shown in FIG. 9, the friction unit 100 may comprise two slots 3 extending along the friction unit radial direction R1 between the opposite long sides 24. The slots 3 are spaced apart from each other in the friction unit circumferential direction C1 so that they are positioned in end regions of the friction pad 2 facing the respective short sides 26. Hence, the slots 3 are positioned in the region where the pressing force of the fingers 205F is applied to the friction unit 100. Thus, they may more efficiently help in reducing pressure peaks.

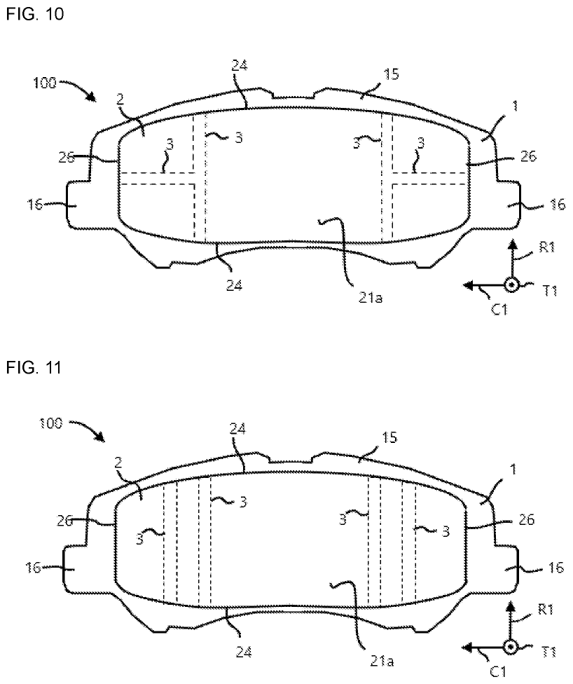

FIG. 10 shows a further friction unit 100 which corresponds to that of FIG. 9, wherein, additionally, one tangential slot 3 is provided with each of the radial slots 3, wherein each tangential slot 3 extends between the respective radial slot 3 and the neighboring short side 26 of the circumference of the underlayer 22. Although not shown, more than one tangential slot may be provided between each radial slot 3 and the adjacently neighboring short side 26.

FIG. 11 shows a further friction unit 100 which corresponds to that of FIG. 9, wherein a pair of radial slots 3 is provided in each end region adjacent to the short sides 26.

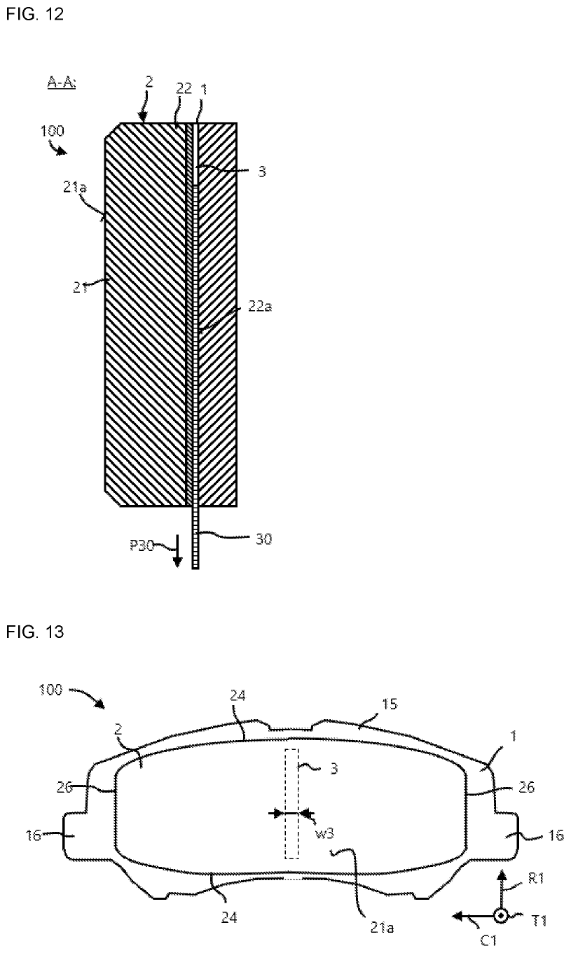

A slot 3 that ends at the circumference of the underlayer 22 may be formed, for example, as schematically illustrated in FIG. 12. As shown in FIG. 12, a web 30 may be placed on the first surface 1a of the support plate 1. The web 30 acts as a mask. When underlayer 22 is applied to the support plate 1, e.g., pressed thereto, the web 30 caves into the underlayer 22, so that the slot 3 is formed where the web 30 is placed. Afterwards, the web 30 is removed, e.g., by pulling it out from between the underlayer 22 and the support plate 1 as indicated in FIG. 12 by arrow P30.

As already mentioned above, FIGS. 13 to 20 show friction units 100 in which the underlayer 22 comprises at least one slot 3 that extends spaced to the circumference of the underlayer 22.

FIGS. 13 to 17 show friction units 100 that may be advantageously used as first friction units 100A in the brake caliper 200 of FIG. 1. That is, they may be moved by the piston 215.

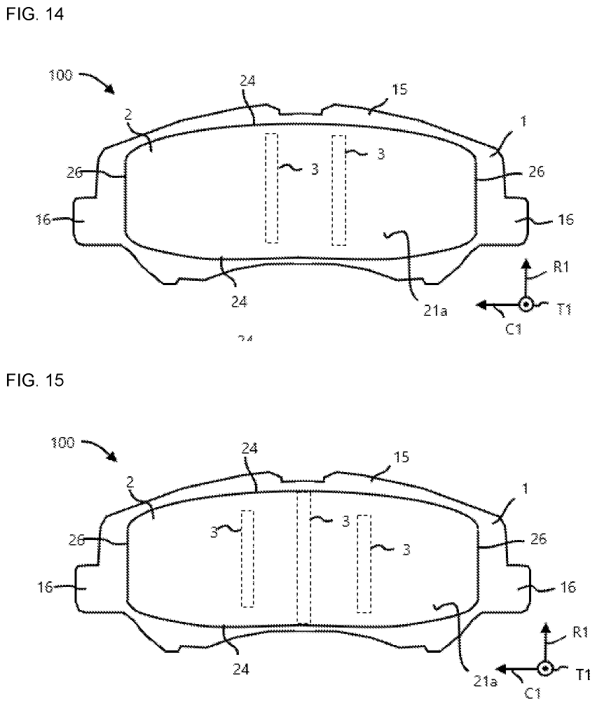

FIG. 13 exemplarily shows a friction unit 100 in which the underlayer 22 includes one single radial slot 3 placed in a central region between the short sides 26 of the circumference. Instead of only one single radial slot 3 more than one radial slot 3 may be provided in the central region, e.g., two slots 3 as shown in FIG. 14, or three slots as shown in FIG. 15. All slots may be formed to extend completely with the underlayer 22, e.g., start and end within the underlayer 22. Alternatively, one or more of multiple slots may end at the circumference of the underlayer 22. For example, FIG. 15 shows a configuration in which two radial slots 3 are provided that extend completely within the underlayer 22 and one radial slot 3 is positioned between those radial slots 3 and extends between the long sides 24.

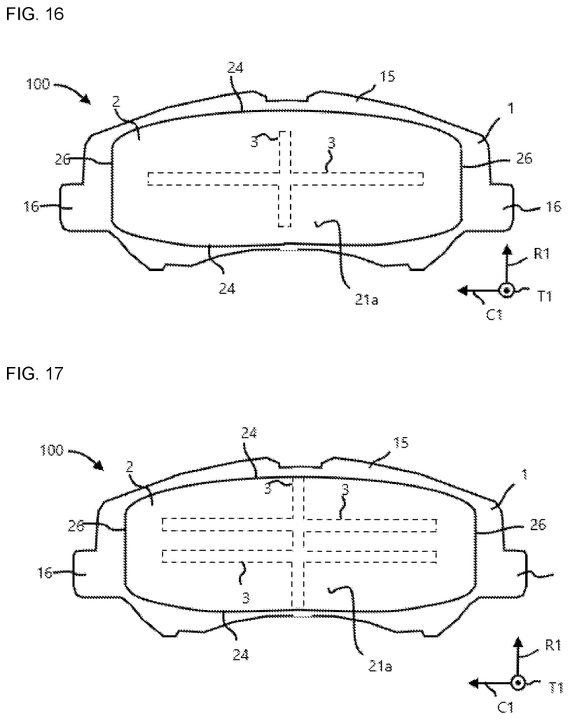

FIG. 16 shows a friction unit 100 similar to that of FIG. 7, with the difference that the radial slot 3 ends distanced to the long sides 24 and the tangential slot 3 ends distanced to the short sides 26. It may also be possible that one of the radial or the tangential slot 3 extends between the short or the long sides 24, 26.

FIG. 17 exemplarily shows a friction unit 100 in which the underlayer 22 comprises one radial slot 3 extending between the long sides 24 of the circumference, and two tangential slots 3 that cross the radial slot 3 and end distanced to both short sides 26.

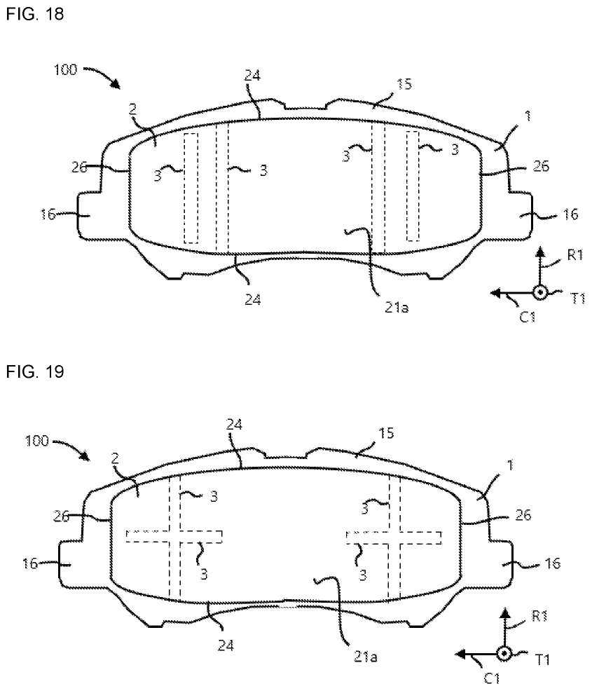

FIGS. 18 to 20 show friction units 100 that may be advantageously used as second friction units 100B in the brake caliper 200 of FIG. 1. That is, they may be pressed against the disk 210 by the second housing portion 205B, e.g., by its fingers 205F.

FIG. 18 shows a friction unit 100 which is similar to that of FIG. 11. In the example of FIG. 18, a pair of radial slots 3 is provided in each end region adjacent to the short sides 26, wherein each pair has a first slot extending between the long sides 24 and a second slot that ends distanced to both long sides 24. As exemplarily shown in FIG. 18, the second slot may be arranged between the first slot and the adjacent short side 26.

FIG. 19 exemplarily shows a friction unit 100 in which the underlayer 22 comprises two radial slots 3 arranged in the end region adjacent to the short sides 26, respectively, wherein each radial slot 3 is crossed by one tangential slot 3, respectively, that ends distanced to the adjacent short side 26 and the neighboring radial slot 3.

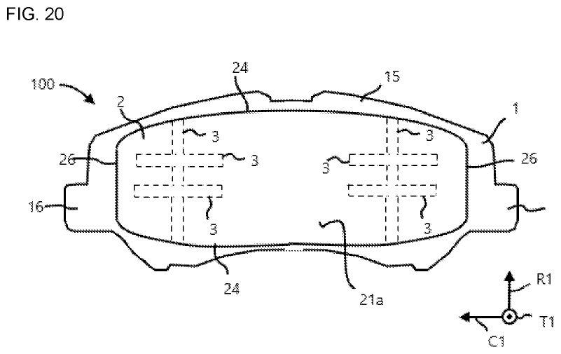

FIG. 20 further shows a friction unit 100 which corresponds to that of FIG. 19 with the only difference that two tangential slots 3 are provided with each radial slot 3.

A slot 3 that extends distanced to the circumference of the underlayer 22 may be formed, for example, by placing or applying the filler material 4 to the first surface 1a of the support plate 1, and then applying the underlayer 22 to the support plate 1. For example, the underlayer material may be pressed to the support plate 1 so that the slot 3 is formed where the filler material 4 is placed.

Although specific embodiments have been illustrated and described herein, it will be appreciated by those of at least ordinary skill in the art that a variety of alternate and/or equivalent implementations exist. It should be appreciated that the exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims. Generally, this application is intended to cover any adaptations or variations of the specific embodiments discussed herein.

What is claimed is:

1. A friction unit (100) for a disk brake (300) of a vehicle, comprising:
a support plate (1); and
a friction pad (2) comprising a friction material layer (21) that includes a contact surface (21a) for contacting a disk (310), and an underlayer (22) including an inner surface (22a) which is oriented opposite to the contact surface (21a) and which is joined to the support plate (1),
wherein the underlayer (22) comprises at least one slot (3), preferably formed in the inner surface (22a).

2. The friction unit (100) of claim 1, wherein the at least one slot (3) ends at a circumference of the underlayer (22).

3. The friction unit (100) of claim 2, wherein the at least one slot (3) extends between opposite portions (24, 26) of a circumference of the underlayer (22).

4. The friction unit (100) of claim 1, wherein the at least one slot (3) extends distanced to a circumference of the underlayer (22).

5. The friction unit (100) of claim 1, wherein the at least one slot (3) forms a void or is filled with a filler material (4).

6. The friction unit (100) of claim 5, wherein the filler material (4) has one or more of the following properties:
a bulk modulus which is at least 30% smaller than that of the underlayer (22);
a Poisson's ratio which is at least 10% greater than that of the underlayer (22);
a Young's modulus which is at least 20% smaller than that of the underlayer (22);
a density which is at least 20% smaller than that of the underlayer (22).

7. The friction unit (100) of claim 5, wherein the filler material (4) includes or is made of a phenolic resin, expanded polystyrene, wood fibers, or rubber.

8. The friction unit (100) of claim 1, wherein the underlayer (22) has predefined thickness (t22), and wherein the at least one slot (3) has a depth (d3) smaller than the thickness (t22) of the underlayer (22) or has a depth (d3) being equal to the thickness (t22) of the underlayer (22) so that it extends completely through the underlayer (22).

9. The friction unit (100) of claim 1, wherein the contact surface (21a) of the friction material layer (21) is a continuous surface having a planar main portion (21p).

10. A brake caliper (200) for a disk brake (300) of a vehicle, comprising:
a carrier (205); and
a friction unit (100) according to any one of the preceding claims which is movably guided within the carrier (205) along an axial direction (A) or fixed within the carrier (205).
